(19) United States
(12) Patent Application Publication
(10) Pub. No.: US 2015/0002248 A1
(43) Pub. Date: Jan. 1, 2015

(54) ELECTROMAGNETIC RELAY

(71) Applicant: FUJITSU COMPONENT LIMITED, Tokyo (JP)

(72) Inventor: Daiei IWAMOTO, Tokyo (JP)

(73) Assignee: FUJITSU COMPONENT LIMITED, Tokyo (JP)

(21) Appl. No.: 14/248,772

(22) Filed: Apr. 9, 2014

(30) Foreign Application Priority Data
Jul. 1, 2013 (JP) 2013-138394

(51) Int. Cl. H01H 1/50; H01H 50/56

(52) U.S. Cl. CPC H01H 1/50; H01H 50/56
USPC 335/192

(57) ABSTRACT

An electromagnetic relay, includes: a first movable contact that comes in contact with a first fixed contact; a second movable contact that comes in contact with a second fixed contact; a first elastic body that biases the first movable contact; a second elastic body that biases the second movable contact; a pressing member that presses the first elastic body and contacts the first movable contact to the first fixed contact, presses the second elastic body and contacts the second movable contact to the second fixed contact; wherein the pressing member contacts the second movable contact to the second fixed contact before contacting the first movable contact to the first fixed contact.

### CROSS-REFERENCE TO RELATED APPLICATION

This application is based upon and claims the benefit of priority of the prior Japanese Patent Application No. 2013-138394 filed on Jul. 1, 2013, the entire contents of which are incorporated herein by reference.

### FIELD

A certain aspect of the embodiments is related to an electromagnetic relay, e.g. an electromagnetic relay that includes a pressing member which presses an elastic body biasing a movable contact.

### BACKGROUND

For example, in Japanese Laid-open Patent Publication No. 2001-126601, an electromagnetic relay includes a yoke which can change a magnetic pole by an electromagnet, and an armature magnetized with a permanent magnet. The polarity of the electromagnet is changed, so that the magnetic pole of the yoke is changed. Thereby, the armature comes in contact with the yoke or detaches from the yoke. The movable contact is biased by an elastic body, and the pressing member presses the elastic body according to the operation of the armature. Thereby, the fixed contact comes in contact with the movable contact or detaches from the movable contact. Therefore, this function as the electromagnetic relay.

### SUMMARY

According to an aspect of the present invention, there is provided an electromagnetic relay, including: a first movable contact that comes in contact with a first fixed contact; a second movable contact that comes in contact with a second fixed contact; a first elastic body that biases the first movable contact; a second elastic body that biases the second movable contact; a pressing member that presses the first elastic body and contacts the first movable contact to the first fixed contact, presses the second elastic body and contacts the second movable contact to the second fixed contact; wherein the pressing member contacts the second movable contact to the second fixed contact before contacting the first movable contact to the first fixed contact.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a side view of an electromagnetic relay according to a first embodiment;

FIG. 2 is a perspective view of the electromagnetic relay removing an armature cover and a connection member;

FIG. 3 is a perspective view of a base cover;

FIG. 4 is a perspective view illustrating an armature and the connection member;

FIG. 5 is a perspective view illustrating the armature and the connection member;

FIG. 6 is a cross-sectional view of a base and the armature cover in an XZ plane;

FIGS. 7A and 7B are views illustrating the operation of the armature;

FIG. 8 is a cross-sectional view of the armature cover in the XZ plane;

FIG. 9 is a view perspective illustrating the configuration of the circumference of the movable contact;

FIG. 10 is a view perspective illustrating the configuration of the circumference of the fixed contact; and

FIG. 11 is a plane view of the movable contact.

### DESCRIPTION OF EMBODIMENTS

In Japanese Laid-open Patent Publication No. 2001-126601, when the fixed contact comes in contact with the movable contact or detaches from the movable contact, a bounce by the collision of the fixed contact and the movable contact occurs. When an energizing current is large, arc discharge occurs in the case of the bounce. Contact welding occurs by the heat of the arc discharge, and the contacts become defect. Rolling of one contact exists as this measure. However, when the energizing current is large, a cross-sectional area of a spring of the contact is enlarged, so that the bending of the spring for leading the rolling cannot be secured adequately.

A description will now be given of embodiment of the present invention with reference to the drawings.

### First Embodiment

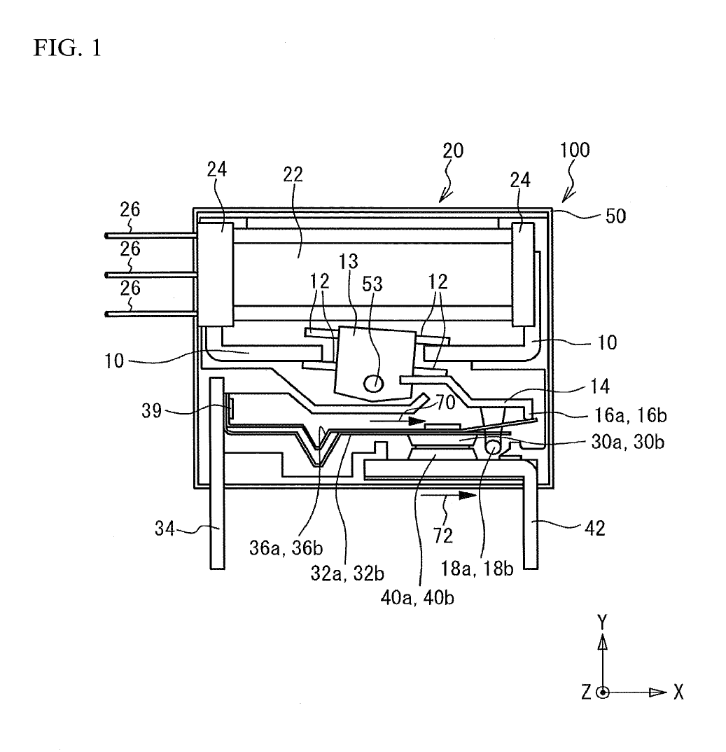

FIG. 1 is a cross-sectional view of an electromagnetic relay according to a first embodiment. In FIG. 1, a base cover is removed from the electromagnetic relay. It is assumed that a direction of a pair of yokes 10 is an X-direction, a direction which intersects perpendicularly in the X-direction of X is a Y-direction, and a direction perpendicular to this paper surface is a Z-direction. Also in the following drawings, the X-, Y- and Z-directions are illustrated similarly. A base 50 houses an electromagnet 20, yokes 10, armatures 12, an armature cover 13, a first contact pressing portion 16a, a second contact pressing portion 16b, a first detachment pressing portion 18a, a second detachment pressing portion 18b, a connection member 14, a first movable contact 30a, a second movable contact 30b, springs 32a and 32b, a movable terminal 34, springs 36a and 36b, a first fixed contact 40a, a second fixed contact 40b, and a fixed terminal 42.

In the electromagnet 20, a coil wire 22 is wound around a bobbin 24. Terminals 26 are electrically connected to the coil wire 22. A pair of yokes 10 is magnetically connected to both sides of the electromagnet 20. The magnetic poles of respective end of a pair of yokes 10 are opposite to each other. When the direction of a current which flows into the coil wire 22 is changed, the polarity of the electromagnet 20 is reversed. Thus, the magnetic poles of the yokes 10 can be changed with the electromagnet. The armatures 12 are magnetized with a permanent magnet, and comes in contact with the yokes 10 or detaches from the yokes 10 by the magnetic poles of the yokes 10. A part of the armatures 12 and the permanent magnet (not shown) are fixed by the armature cover 13.

The first movable contact 30a is electrically connected to the movable terminal 34 via the spring 32a (a first elastic body). The second movable contact 30b is electrically connected to the movable terminal 34 via the spring 32b (a second elastic body). The springs 32a and 32b are fixed to the movable terminal 34 with a fixed portion 39. The first fixed contact 40a and the second fixed contact 40b are electrically connected to the fixed terminal 42. When the first movable contact 30a comes in contact with the first fixed contact 40a, and the second movable contact 30b comes in contact with the second fixed contact 40b, the movable terminal 34 is electrically connected to the fixed terminal 42. When the first movable contact 30a detaches from the first fixed contact 40a, and the second movable contact 30b detaches from the second fixed contact 40b, the movable terminal 34 and the fixed terminal 42 become non-conduction electrically.

The first movable contact 30a is biased by the springs 32a and 36a so as to detach from the first fixed contact 40a. The first contact pressing portion 16a presses the springs 32a and 36a in a −Y direction, so that the first movable contact 30a comes in contact with the first fixed contact 40a. The first detachment pressing portion 18a presses the springs 32a and 36a in a +Y direction, so that the first movable contact 30a detaches from the first fixed contact 40a.

The second movable contact 30b is biased by the springs 32b and 36b so as to detach from the second fixed contact 40b. The second contact pressing portion 16b presses the springs 32b and 36b in the −Y direction, so that the second movable contact 30b comes in contact with the second fixed contact 40b. The second detachment pressing portion 18b presses the springs 32b and 36b in the +direction, so that the second movable contact 30b detaches from the second fixed contact 40b. Here, in the above-mentioned example, a plurality of blade springs such as the springs 32a and 36a are used as the first elastic body, and a plurality of another blade springs such as the springs 32b and 36b are used as the second elastic body. The first elastic body and the second elastic body should be members which biases the first movable contact 30a and the second movable contact 30b, respectively.

The connection member 14 connects the first contact pressing portion 16a, the second contact pressing portion 16b, the first detachment pressing portion 18a and the second detachment pressing portion 18b with the armature cover 13.

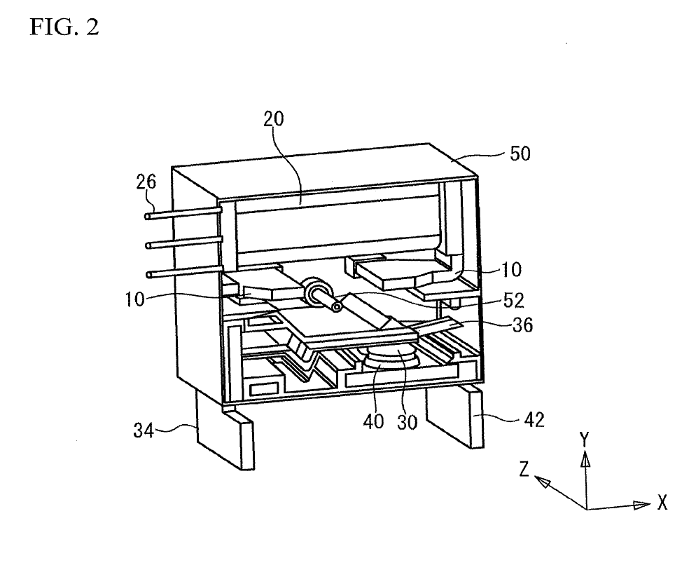

FIG. 2 is a perspective view of the electromagnetic relay removing the armature cover 13 and the connection member 14. As illustrated in FIG. 2, a base rotary-shaft-projection 52 is formed on the base 50. Since other configurations are the same as those of FIG. 1, description thereof is omitted.

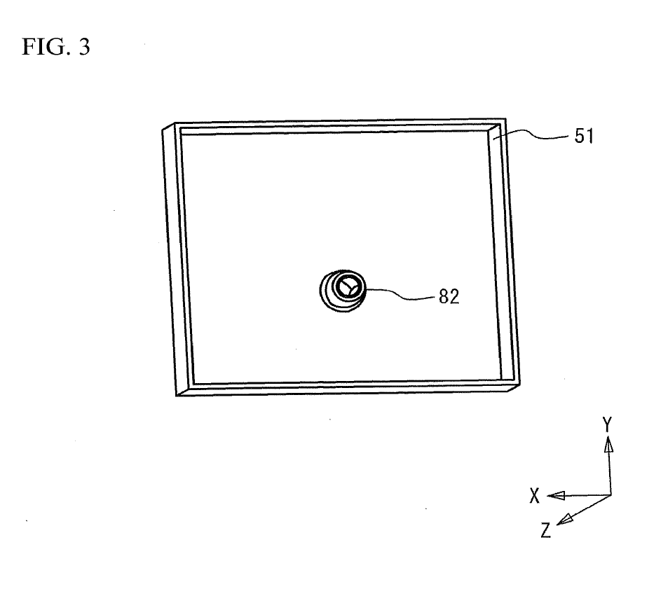

FIG. 3 is a perspective view of a base cover 51. As illustrated in FIG. 3, a cover rotation bearing 82 is formed on the base cover 51.

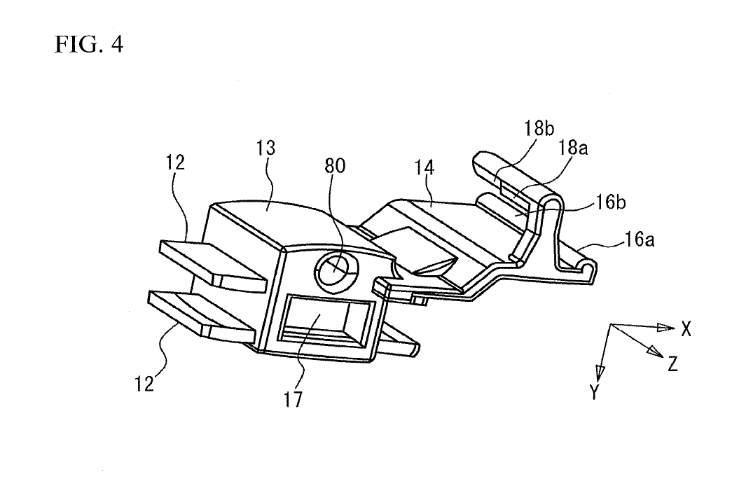

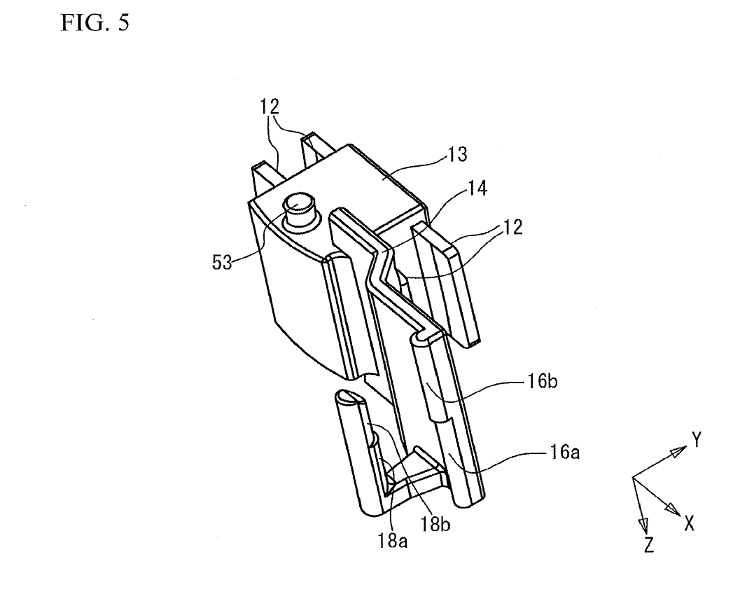

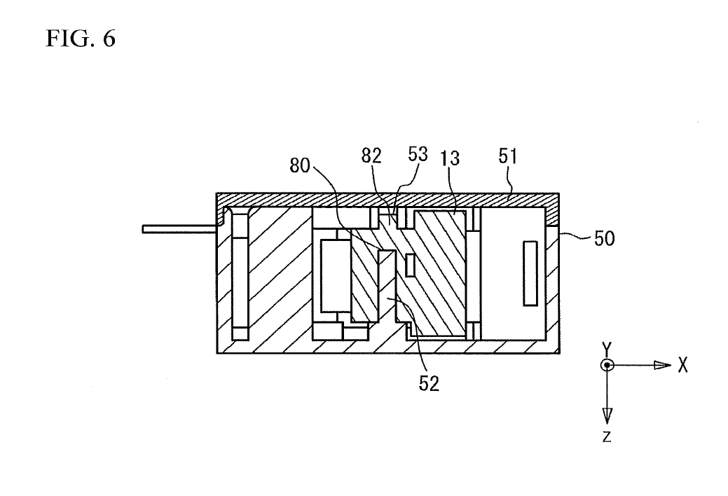

FIGS. 4 and 5 are perspective views illustrating the armature and the connection member. FIG. 6 is a cross-sectional view of the base and the armature cover in an XZ plane. As illustrated in FIGS. 4 to 6, a concave portion is formed on the armature cover 13, and a permanent magnet 17 is embedded in the concave portion. An armature rotation bearing 80 and an armature rotary-shaft-projection 53 are formed on the armature cover 13. The base rotary-shaft-projection 52 of FIG. 2 is inserted into the armature rotation bearing 80. The armature rotary-shaft-projection 53 is inserted into the cover rotation bearing 82 of FIG. 3.

A pressing member is formed at the tip of the connection member 14. The pressing member includes the first contact pressing portion 16a, the second contact pressing portion 16b, the first detachment pressing portion 18a and the second detachment pressing portion 18b. A step is formed between the second contact pressing portion 16b and the first contact pressing portion 16a so that the second contact pressing portion 16b projects in the −Y direction compared with the first contact pressing portion 16a. Thereby, a distance from the spring 36a to the first contact pressing portion 16a becomes longer than a distance from the spring 36b to the second contact pressing portion 16b. A step is formed between the first detachment pressing portion 18a and the second detachment pressing portion 18b so that the first detachment pressing portion 18a projects in the +Y direction, compared with the second detachment pressing portion 18b. Thereby, a distance from the spring 32a to the first detachment pressing portion 18a becomes shorter than a distance from the spring 32b to the second detachment pressing portion 18b.

The armature cover 13, the connection member 14, and the pressing portions 16a, 16b, 18a and 18b are integrally formed with resin, for example.

The springs 32a, 32b, 36a and 36b are not integrally formed with the armature cover 13, the connection member 14, and the pressing portions 16a, 16b, 18a and 18b, and can be separated from the pressing portions 16a, 16b, 18a and 18b.

By pressing the first elastic body, the pressing portions 16a and 16b cause the first movable contact 30a to perform at least one of the contact with the first fixed contact 40a and the detachment from the first fixed contact 40a. By pressing the second elastic body, the pressing portions 18a and 18b cause the second movable contact 30b to perform at least one of the contact with the second fixed contact 40b and the detachment from the second fixed contact 40b.

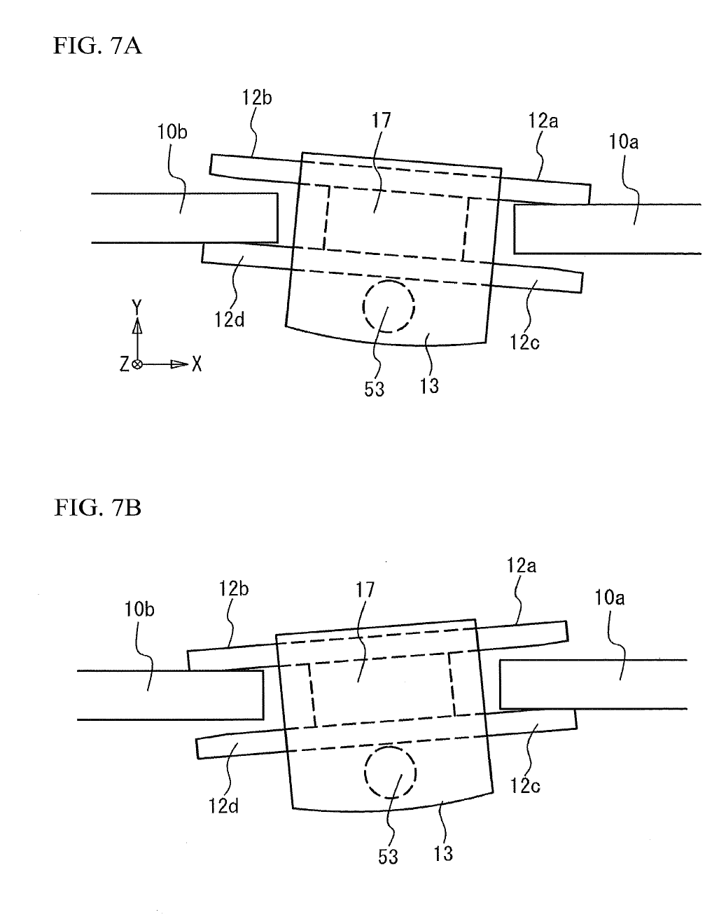

FIGS. 7A and 7B are views illustrating the operation of the armature. Referring to FIG. 7A, when an end 10a of one of the yokes 10 and the armatures 12c and 12d have the same polarity, and an end 10b of another one of the yokes 10 and the armatures 12a and 12b have the same polarity, the armatures rotates so that the armature 12a comes in contact with the end 10a and the armature 12d comes in contact with the end 10b. Referring to FIG. 7B, when the end 10a and the armatures 12a and 12b have the same polarity, and the end 10b and the armatures 12c and 12d have the same polarity, and the armatures rotates so that the armature 12c comes in contact with the end 10a and the armature 12b comes in contact with the end 10b. Thus, a pair of yokes 10 are provided. The armatures 12 are formed so as to sandwich each of the ends 10a and 10b of the pair of yokes 10. The armature cover 13 rotates, so that the he armatures 12 come in contact with the ends 10a and 10b or detaches from the ends 10a and 10b. Cost reduction can be performed by making the two armatures 12 into the same shape, for example.

The armature rotary-shaft-projection 53 is not arranged on a central line of the yokes 10, and is arranged on the outside of the pair of armatures 12. Therefore, a volume of the permanent magnet 17 located between the armatures 12 can be secured adequately, and a relay excellent in shock resistance can be offered.

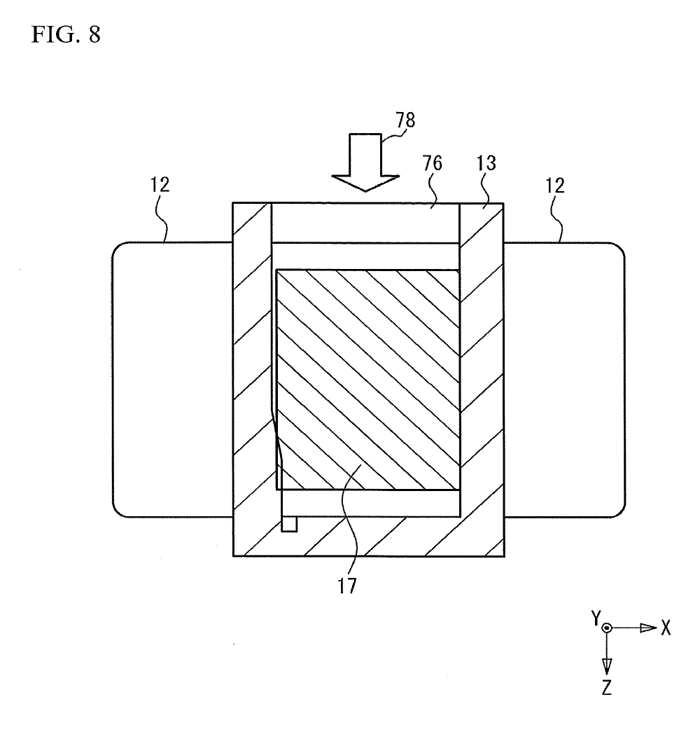

FIG. 8 is a cross-sectional view of the armature cover in the XZ plane. After integral mold forming of the armature cover 13 and the pressing member is preformed, the permanent magnet 17 is inserted from an insertion slot 76 as illustrated by an arrow 78 of FIG. 8. The permanent magnet 17 may be embedded by mold forming However, in this case, the equipment for performing magnetization to the armatures 12 is used after mold forming When the permanent magnet 17 is inserted after mold forming as illustrated in FIG. 8, the size of the permanent magnet 17 can be changed easily. Thereby, the magnetization can be performed easily. Therefore, the equipment for performing the magnetization to the armatures 12 becomes unnecessary. In addition, series products of the electromagnetic relay by the performance and cost are enabled. For example, a samarium-cobalt magnet can be used as the permanent magnet 17.

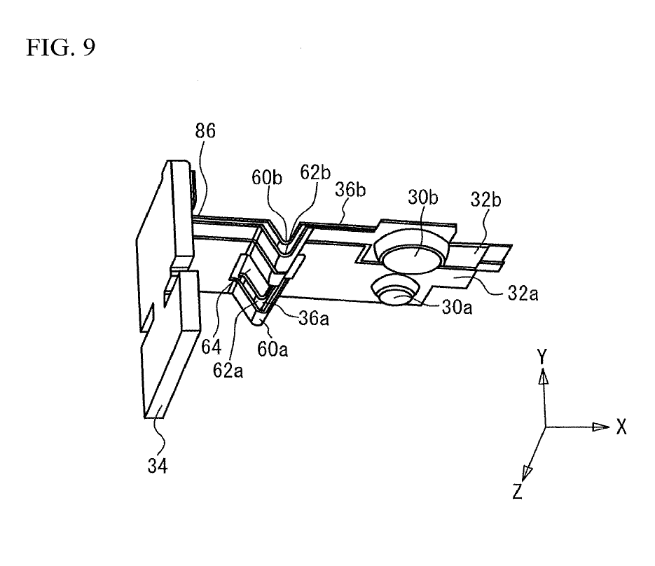

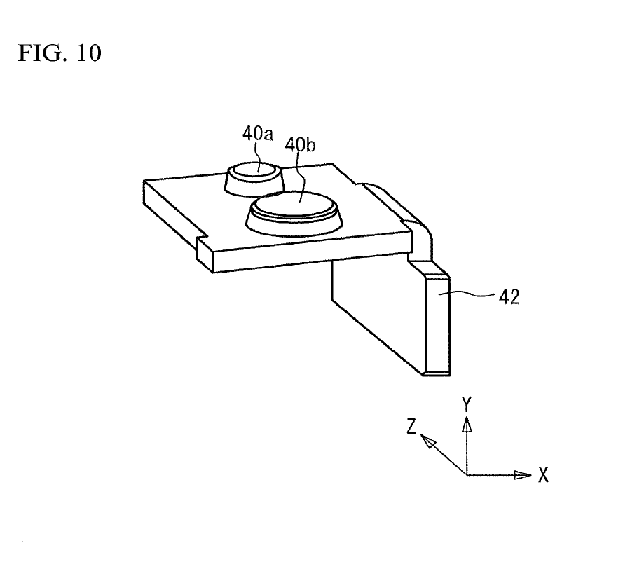

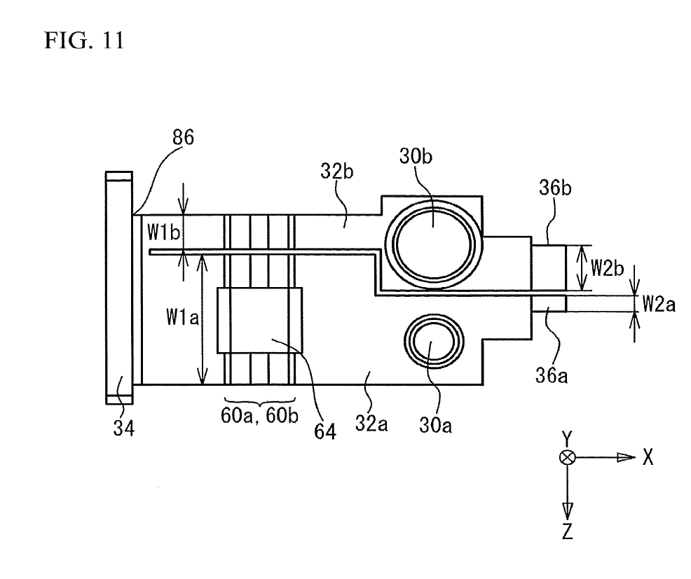

FIG. 9 is a view perspective illustrating the configuration of the circumference of the movable contact. FIG. 10 is a view perspective illustrating the configuration of the circumference of the fixed contact. FIG. 11 is a plane view of the movable contact. The pressing portions 16a and 16b contact the second movable contact 30b to the second fixed contact 40b, before contacting the first movable contact 30a to the first fixed contact 40a. Thus, a time lag is provided in the contact between the two sets of contacts. Thereby, the fixed contact and the movable contact which contact early can take charge of the heat of the arc discharge by the bounce at the time of contact. Here, each of the first elastic body and the second elastic body may be a single spring.

Moreover, the first movable contact 30a is smaller than the second movable contact 30b, as illustrated in FIGS. 9 to 11. The first fixed contact 40a is smaller than the second fixed contact 40b. The second fixed contact 40b and the second movable contact 30b which are relatively large come in contact with each other before the first fixed contact 40a and the first movable contact 30a which are relatively small come in contact with each other. Therefore, the pair of the fixed contact and the movable contact which have large volumes can take charge of the heat of the arc discharge by the bounce at the time of the contact. Since a large contact has a permissible dose of the heat larger than a small contact, it is possible to avoid a failure by the welding.

Moreover, the pressing portions 18a and 18b detach the second movable contact 30b from the second fixed contact 40b after detaching the first movable contact 30a from the first fixed contact 40a. Thus, a time lag is provided in the detachment between the two sets of contacts. Thereby, at the time of the detachment, small contacts are mutually detached in first (the current is not interrupted at this time), and then large contacts are mutually detached (the current is interrupted at this time). Therefore, the contacts having a large heat capacity also can take charge of the arc discharge at the time of the detachment. The large contacts take charge of the arc discharge which occurs at the time of the contact and the detachment. Since the small contacts do not take charge of the arc discharge, the small contacts do not receive a damage, and hence an effect of reducing a contact resistance of the movable contact and the fixed contact at the time of the contact of the movable contact and the fixed contact can be expected.

Moreover, the first contact pressing portion 16a presses the first elastic body to contact the first movable contact 30a to the first fixed contact 40a. The second contact pressing portion 16b presses the second elastic body to contact the second movable contact 30b to the second fixed contact 40b. The distance from the spring 36a (i.e., the first elastic body) to the first contact pressing portion 16a is longer than the distance from the spring 36b (i.e., the second elastic body) to the second contact pressing portion 16b. Thereby, a time lag can be provided in the contact between the two sets of contacts.

Moreover, the first detachment pressing portion 18a (i.e., a first detachment portion) presses the first elastic body to detach the first movable contact 30a from the first fixed contact 40a. The second detachment pressing portion 18b (i.e., a second detachment portion) presses the second elastic body to detach the second movable contact 30b from the second fixed contact 40b. The distance from the spring 32a (i.e., the first elastic body) to the first detachment pressing portion 18a is shorter than the distance from the spring 32b (i.e., the first elastic body) to the second detachment pressing portion 18b. Thereby, a time lag can be provided in the detachment between the two sets of contacts.

Moreover, a width W1a of the first elastic body between the first movable contact 30a and a fixed portion 86 of the first elastic body is wider than a width W1b of the second elastic body between the second movable contact 30b and the fixed portion 86 of the second elastic body, as illustrated in FIG. 11. Thereby, bending of the first elastic body for the movable contact that first comes in contact with the fixed contact can be enlarged, and rolling effects can be more exerted.

Moreover, a width W2a of the first elastic body of a portion (i.e., a position) with which the first contact pressing portion 16a comes in contact is narrower than a width W2b of the second elastic body of a portion (i.e., a position) with which the second contact pressing portion 16b comes in contact, as illustrated in FIG. 11. Thereby, bending of the first elastic body for the movable contact that first comes in contact with the fixed contact can be enlarged, and rolling effects can be more exerted.

Moreover, the springs 32a and 36a include curved portions 60a and 62a which curve into a V-shape between the first movable contact 30a and the fixed portion 86, as illustrated in FIGS. 9 and 11. The springs 32b and 36b include curved portions 60b and 62b which curve into a V-shape between the second movable contact 30b and the fixed portion 86, as illustrated in FIGS. 9 and 11. Thereby, bending of the elastic bodies can be secured.

Moreover, the springs 32a and 36a include an opening 64 in the curved portions 60a and 62a. Thereby, bending of the elastic body can be secured.

Moreover, the first elastic body includes two springs which are the spring 36a (i.e., a third elastic body) and the spring 32a (i.e., a fourth elastic body) arranged so as to overlap with the spring 36a, as illustrated in FIG. 9. In an example of FIG. 9, the spring 36a is pressed by the first contact pressing portion 16a, and the spring 32a is pressed by the first detachment pressing portion 18a. The second elastic body includes two springs which are the spring 36b (i.e., a fifth elastic body) and the spring 32b (i.e., a sixth elastic body) arranged so as to overlap with the spring 36b. In the example of FIG. 9, the spring 36b is pressed by the second contact pressing portion 16b, and the spring 32b is pressed by the second detachment pressing portion 18b. Since each of the first elastic body and the second elastic body has a plurality of blade springs, an energizing current can be enlarged. In addition, the springs 32a and 32b are made thicker than the springs 36a and 36b. Thereby, each of the first elastic body and the second elastic body can be made soft at the time of the contact, and can be hardened at the time of the detachment.

Moreover, the springs 32a and 32b serve as current pathways. Therefore, material with high conductivity is used for the springs 32a and 32b. On the contrary, since the springs 36a and 36b are formed independently from the springs 32a and 32b, material with high spring characteristic can be used for the springs 36a and 36b. A copper alloy, such as a Cu—Cr based alloy with high conductivity or a Cu-Fe based alloy with high conductivity, can be used as the springs 32a and 32b. Phosphor bronze, such as a Cu—Sn based alloy with high spring characteristic, can be used as the springs 36a and 36b. Moreover, when a Cu—Cr—Zr—Si based alloy with high conductivity and high spring characteristic is used as the springs 36a and 36b, the rise in temperature of the electromagnetic relay when a current is supplied can be controlled. Moreover, the resistance characteristic of the spring by repetition operation can be improved. Here, the Cu—Cr—Zr—Si based alloy may be used for the springs 32a and 32b.

Moreover, since the movable terminal 34 and the fixed terminal 42 are arranged as illustrated in FIG. 1, a direction of a current (hereinafter referred to as “a current direction 70”) which flows into the first movable contact 30a and flows out from the first movable contact 30a, and a direction of a current (hereinafter referred to as “a current direction 72”) which flows into the first fixed contact 40a and flows out from the first fixed contact 40a are the same direction. The current direction 70 which flows into the second movable contact 30b and flows out from the second movable contact 30b, and the current direction 72 which flows into the second fixed contact 40b and flows out from the second fixed contact 40b are the same direction.

That is, the current direction 70 which flows into the first movable contact 30a and the second movable contact 30b from the movable terminal 34, and the current direction 72 which flows out from the first fixed contact 40a and the second fixed contact 40b to the fixed terminal 42 are the same direction. Alternatively, a current direction (i.e., a direction opposite to the direction 70) which flows out from the first movable contact 30a and the second movable contact 30b to the movable terminal 34, and a current direction (i.e., a direction opposite to the direction 72) which flows into the first fixed contact 40a and the second fixed contact 40b from the fixed terminal 42 are the same direction.

When a large current (for example, several thousand amperes) flows by the malfunction of a system, and the current directions 70 and 72 are opposite directions mutually, an electromagnetic repulsive force arises between the contacts by Ampere's corkscrew law. Therefore, a force acts on a direction where the movable contact which is in a contact state detaches, the arc discharge occurs when the movable contact detaches, and hence the contact welding may arise. However, according to the first embodiment, since the current directions 70 and 72 are the same directions, the detachment of the movable contact can be controlled even when the large current flows.

As illustrated in FIG. 1, the fixed terminal 42 and the movable terminal 34 are pulled out in the −Y direction from mutual different positions (the +X side and the −X side), as viewed from the contacts. Thereby, the fixed terminal 42 and the movable terminal 34 can be shortened, compared with a case where the fixed terminal 42 and the movable terminal 34 are pulled out in the −Y direction from the same contact side (e.g. the −X side of the contact). Moreover, a space for forming the curved portions 60a, 60b, 62a and 62b can be provided.

When slight contact welding occurs, the rotary shaft of the armature cover 13 inclines and the rotation is inhibited. Thereby, it becomes difficult to detach the contacts from each other even when the slight welding is essentially detachable. According to the first embodiment, the armature rotation bearing 80 and the armature rotary-shaft-projection 53 are formed on the armature cover 13, as illustrated in FIGS. 2 to 6. The base rotary-shaft-projection 52 is inserted into the armature rotation bearing 80. The armature rotary-shaft-projection 53 is inserted into the cover rotation bearing 82. Thereby, the armature cover 13 can rotate efficiently. Therefore, the welding of the contacts can be controlled.

Moreover, a distance from the springs 32a and 32b to the detachment pressing portions 18a and 18b when the detachment pressing portions 18a and 18b are detached from the springs 32a and 32b is longer than a distance from the springs 32a and 32b to the contact pressing portion 16a and 16b when the contact pressing portion 16a and 16b are detached from the springs 32a and 32b. Thereby, when the detachment pressing portions 18a and 18b come in contact with the springs 32a and 32b, the detachment pressing portions 18a and 18b having a speed collide with the springs 32a and 32b. This collision can tear off the movable contact. Therefore, welding failure of the contacts can be more controlled.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. An electromagnetic relay, comprising:
a first movable contact that comes in contact with a first fixed contact;
a second movable contact that comes in contact with a second fixed contact;
a first elastic body that biases the first movable contact;
a second elastic body that biases the second movable contact ; and
a pressing member that presses the first elastic body and contacts the first movable contact to the first fixed contact, presses the second elastic body and contacts the second movable contact to the second fixed contact;
wherein the pressing member contacts the second movable contact to the second fixed contact before contacting the first movable contact to the first fixed contact.

2. The electromagnetic relay as claimed in claim 1, wherein contact volumes of the second movable contact and the second fixed contact are larger than contact volumes of the first movable contact and the first fixed contact.

3. The electromagnetic relay as claimed in claim 1, wherein the pressing member includes a first contact pressing portion that presses the first elastic body, and a second contact pressing portion that presses the second elastic body, and
a distance from the first elastic body to the first contact pressing portion is longer than a distance from the second elastic body to the second contact pressing portion.

4. The electromagnetic relay as claimed in claim 1, wherein the pressing member detaches the first movable contact from the first fixed contact and detaches the second movable contact from the second fixed contact, and the pressing member detaches the second movable contact from the second fixed contact after detaching the first movable contact from the first fixed contact.

5. The electromagnetic relay as claimed in claim 4, wherein the pressing member includes a first detachment portion that detaches the first movable contact from the first fixed contact and a second detachment portion that detaches the second movable contact from the second fixed contact, and
a distance from the first elastic body to the first detachment portion is shorter than a distance from the second elastic body to the second detachment portion.

6. The electromagnetic relay as claimed in claim 1, wherein a width of the first elastic body between the first movable contact and a fixed potion of the first elastic body is wider than a width of the second elastic body between the second movable contact and a fixed potion of the second elastic body.

7. The electromagnetic relay as claimed in claim 3, wherein a width of the first elastic body at a portion with which the first contact pressing portion comes in contact is narrower than a width of the second elastic body at a position with which the second contact pressing portion comes in contact.

8. The electromagnetic relay as claimed in claim 1, wherein the first elastic body curves between the first movable contact and a fixed potion of the first elastic body, and the second elastic body curves between the second movable contact and a fixed potion of the second elastic body.

9. The electromagnetic relay as claimed in claim 5, wherein the first elastic body includes a third elastic body that is pressed by the first contact pressing portion, and a fourth elastic body that overlaps with the third elastic body and is pressed by the first detachment portion, and
the second elastic body includes a fifth elastic body that is pressed by the second contact pressing portion presses, and a sixth elastic body that overlaps with the fifth elastic body and is pressed by the second detachment portion.

10. The electromagnetic relay as claimed in claim 1, wherein a direction of a current which flows into the first movable contact or flows out from the first movable contact, and a direction of a current which flows into the first fixed contact or flows out from the first fixed contact are the same direction, and
a direction of a current which flows into the second movable contact or flows out from the second movable contact, and a direction of a current which flows into the second fixed contact or flows out from the second fixed contact are the same direction.
